(19) United States
(12) Patent Application Publication
(10) Pub. No.: US 2009/0156720 A1
(43) Pub. Date: Jun. 18, 2009

(54) Polyethersulfone-Based Resin Composition and Molded Article Thereof

(75) Inventors: Toyonari ITO, Tsukuba-shi (JP); Satoshi OKAMOTO, Tsukuba-shi (JP)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: Sumitomo Chemical Company, Limited, Tokyo (JP)

(21) Appl. No.: 12/329,807

(22) Filed: Dec. 8, 2008

(30) Foreign Application Priority Data
Dec. 10, 2007 (JP) 2007-318006

(51) Int. Cl. C08L 81/06; C08K 5/17

(52) U.S. Cl. 524/186; 524/609

(57) ABSTRACT

The present invention provides a resin composition comprising (A) a polyethersulfone-based resin and (B) a compound having a weight reduction starting temperature determined in JIS K7120 of 150° C. or higher, a melting point of 100° C. or higher and a molecular weight of 500 or less, in a ratio (A):(B) within a range of from 100:5 to 100:1, in terms of a weight ratio. The polyethersulfone-based resin composition has high fluidity in a molten state and emit deduced smaller amounts of gas in processing. The molded article obtained from the composition also generate smaller amounts of gas discharged while being utilized.

### BACKGROUND OF THE INVENTION

1. Field of the Invention

The present invention relates to a polyethersulfone-based resin composition and a molded article composed of the polyethersulfone-based resin composition.

2. Description of the Related Art

A polyethersulfone-based resin (hereinafter referred to as a “PES resin”) is a plastic having an oxy group (—O—) and a sulfonyl group (—SO₂—) as a linking group, aromatic rings being bonded with each other through the linking group, and is widely used for not only general-purpose products such as heat-resistant tablewares but also products in advanced technical fields such as electric and electronic filed, utilizing excellent characteristics such as water resistance, heat resistance and mechanical strength. On the other hand, with the trends to reduction in size and complication of shape of parts in the electric and electronic filed, it is preferable to use raw materials which have high fluidity in a molten state and are less likely to discharge a gas during processing. Thus, it was required to develop such raw materials.

J. Appl. Polym. Sci. Vol. 103, 2627-2633 (2007) discloses a study regarding the effects of the addition of low molecular weight additives on properties of PES resin. According to the article, it has been known that, when small amounts of certain low molecular weight materials are added to glassy polymers, then a mobility restriction of the polymeric chains is observed, which is usually the opposite of that observed when large amounts of plasticizers are added to the polymers. Such an unusual phenomenon is called antiplasticization. (See, INTRODUCTION of the article.) The authors of the article conducted a study utilizing the antiplasticization in which low molecular weight materials were added to PES resins to prepare mixtures of the materials at 5, 10, 15, 20 and 30 wt % concentrations (i.e., 5.26, 11.1, 17.6, 25.0 and 42.9 parts by weight of the materials were added respectively to 100 parts by weight of PES resins). The addition of the materials restricts molecular mobility of the PES compositions, thereby reducing water vapor permeability of the PES compositions.

### SUMMARY OF THE INVENTION

On the contrary, the inventors of the present invention have found that when materials having certain physical properties are added to PES resins in much smaller amounts compared to the above, then flowability in molten state of the PES resin is increased (compared to that of PES with no such materials added) and the resulting PES resin compositions and the molded article thereof can discharge reduced smaller amounts of gas in processing.

Under such circumstances, one of objects of the present invention is to provide a PES resin composition which has a high fluidity in a molten state and is less likely to discharge a gas during processing. As a result of research, the present inventors have found such a PES resin composition with high fluidity in a molten state and smaller amounts of gas discharged in processing, and have found that the molded article obtained from such a PES resin composition also generate smaller amounts of gas discharged while being utilized.

Thus, the present invention provides a resin composition comprising the following components (A) and (B):
(A) a polyethersulfone-based resin, and
(B) a compound having a weight reduction starting temperature determined in JIS K7120 of 150° C. or higher, a melting point of 100° C. or higher and a molecular weight of 500 or less,
   wherein a content ratio (A):(B) is within a range of from 100:5 to 100:1 in terms of a weight ratio.

### DETAIL DESCRIPTION OF PREFERRED EMBODIMENTS

A resin composition of the present invention comprises:
(A) a polyethersulfone-based resin, and
(B) a compound having a weight reduction starting temperature determined in JIS K7120 of 150° C. or higher, a melting point of 100° C. or higher and a molecular weight of 500 or less.

The low molecular-weight compound (B) used in the present invention has a high weight reduction starting temperature and a high melting point.

Specifically, the weight reduction starting temperature is 150° C. or higher, preferably 160° C. or higher, and more preferably 180° C. or higher. The melting point is 100° C. or higher, preferably 110° C. or higher. It is preferred that the compound (B) is appropriately selected so as to have the upper limit of the melting point depending on the melting temperature of a PES resin (A) (described below) to be used in combination. For example, when the melting temperature of the polyethersulfone-based resin (A) is Ts ° C., the upper limit of the melting point of the compound (B) is preferably lower than Ts by 50° C., and more preferably lower than Ts by 100° C.

In the present invention, the weight reduction starting temperature is determined by a measurement based on “one stage mass reduction” in JIS K 7120 (1997) “Method for Measurement of Thermogravimetry of Plastics”.

As mentioned above, the low molecular weight compound (B) has a molecular weight of 500 or less. The low molecular weight of compound (B) works the compound (B) to have excellent compatibility with a PES resin (A) (described below) to be used in combination. From such a viewpoint, the molecular weight of the low molecular weight compound (B) is more preferably 450 or less.

The low molecular weight compound (B) preferably has a polar functional groups selected from an acidic group and a basic group in the molecule. Such a functional group has an advantage that the action of hydrogen bond ability enables an increase of the weight reduction starting temperature and the melting point, and is also expected to improve a compatibility with a PES-based resin (A).

Examples of the acidic group include phenolic hydroxyl group, carboxyl group (—COOH), phosphonic acid group (—PO₃H₂) and sulfonic acid group (—SO₃H) . Examples of the basic group include an amino group (—N(R)₂ wherein R is a hydrogen atom of a monovalent hydrocarbon group and two R(s) may be the same or different) and a quaternary ammonium group (—N⁺(R′)₃ wherein R′ is a hydrogen atom or a monovalent hydrocarbon group and three R′(s) may be the same or different). The number of the polar functional groups in the lower molecular weight compound (B) can be appropriately optimized so as to adjust the weight reduction starting temperature and the melting point within the above ranges. When the low molecular weight compound having a strong acidic group or a strong basic group is used, water absorbability of the resultant molded article may deteriorate. In this respect, the polar functional group is preferably an acidic group having relatively low acidity or a basic group having relatively low basicity. More preferable polar functional groups of the compound (B) are a phenolic hydroxyl group and an amino group. Among the amino group, a primary amino group (—NH₂) is most preferably used.

The low molecular weight compound (B) is particularly preferably an aromatic compound since the aromatic compound can advantageously elevate both of the weight reduction starting temperature and the melting point of the resultant composition. The term “aromatic compound” means a compound having one or more aromatic ring(s) in its molecule. Since the PES-based resin (A) used together in the present invention has an aromatic group (as described below), the aromatic compound as the low molecular weight compound (B) exhibits more excellent compatibility with the PES-based resin (A) in the resultant composition.

Examples of the low molecular weight compound (B) include those which are more compatible with the PES-based resin (A) . Specific examples of those compound (B) include hexafluorobisphenol A, bisphenol A, N-phenyl-2-naphthylamine, 6-hydroxy-2-naphthoic acid, 4-hydroxybenzoic acid and 4,4′-sulfonylbiphenol. Among them, hexafluorobisphenol A (hereinafter, sometimes referred to as “HFBA”) and N-phenyl-2-naphthylamine (hereinafter sometimes referred to as “PNA”) are preferable as the low molecular weight compound (B) used in the present invention. Two or more of the low molecular weight compounds (B) may be used together as long as it does not have adverse effects. For example, the low molecular weight compound (B) having an acidic group and the low molecular weight compound (B) having a basic group can be used together when formation of the salt of them can be suppressed.

A PES-based resin (A) used in the present invention has an aromatic group on the main chain and also has an oxy group and a sulfonyl group as linking groups of the aromatic group. (PES [symbol] [symbol] [symbol] [symbol] ) Preferable PES-based resin (A) has a structural unit of the formula (1) below:

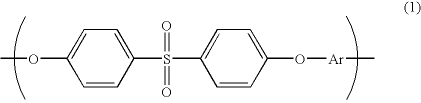

wherein Ar represents a divalent group having an aromatic ring, which may be selected from the units below:

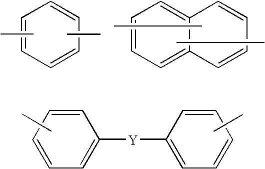

wherein Y represents a single bond, —SO₂—, —C(CH₃)₂— or —O—. In the units, the positions of the two single bonds attached to the benzene or naphthalene rings are not limited as shown above.

The PES-based resin can be produces by the method described below.

The PES-based resin (A) can be obtained by a method of polycondensing a dihalodiphenyl compound with a divalent phenol compound in an organic solvent in the presence of an alkali metal compound, or a method of polycondensing an alkali metal dimetal phenoxide of a dihydric phenol with a dihalodiphenyl compound in an organic solvent.

The organic solvent is preferably an organic polar solvent. Examples thereof include sulfoxide-based solvents such as dimethyl sulfoxide; amide solvents such as N,N-dimethylformamide and N,N-dimethylacetoamide; pyrrolidone-based solvents such as N-methyl-2-pyrrolidone and N-vinyl-2-pyrrolidone; piperidone-based solvents such as N-methyl-2-piperidone; 2-imidazolinone-based solvents such as 1,3-dimethyl-2-imidazolidinone; ketone solvents such as hexamethylphosphoramide, γ-butyrolactone, sulfolane, diphenylether and diphenylsulfone; and mixtures of two or more kinds of them. The organic solvent is preferably an organic solvent selected from the group consisting of N-methyl-2-pyrrolidone, N,N-dimethylacetoamide, dimethylsulfone, diphenylsulfone, dimethyl sulfoxide, dimethylformamide, hexamethylphosphoramide, γ-butyrolactone, sulfolane, 1,3-dioxolane and 1,3-dimethyl-2-imidazolidinone.

Examples of the alkali metal compound include alkali metal carbonate, alkali metal hydroxide, alkali metal hydride and alkali metal alkoxide. Anhydrous metal carbonates such as potassium carbonate and sodium carbonate are particularly preferable.

Examples of the dihalodiphenyl compound include dihalodiphenyl compounds having a sulfone group, for example, dihalodiphenylsulfones such as 4,4′-dichlorodiphenylsulfone and 4,4′-difluorodiphenylsulfone; bis(halogenophenylsulfonyl)benzenes such as 1,4-bis(4-chlorophenylsulfonyl)benzene and 1,4-bis(4-fluorophenylsulfonyl)benzene; and bis(halogenophenylsulfonyl)bisphenyls such as 4,4′-bis(4-chlorophenylsulphonyl)biphenyl and 4,4′-bis(4-fluorophenylsulphonyl)biphenyl. Two or more kinds of these dihalodiphenyl compounds may be used in combination. Among them, dihalodiphenylsulfones are preferable in view of easy availability, and 4,4′-dichlorodiphenylsulfone and 4,4′-difluorodiphenylsulfone are more preferable, and 4,4′-dichlorodiphenylsulfone represented by the following formula (3) is particularly preferable.

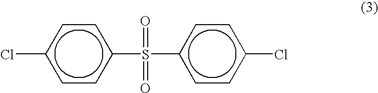

Examples of the dihydric phenol compound include, in addition to hydroquinone, catechol, resorcin and 4,4′-biphenol, bis(4-hydroxyphenyl)alkanes such as 2,2-bis(4-hydroxyphenyl)propane, 2,2-bis(4-hydroxyphenyl)methane and 2,2-bis(4-hydroxyphenyl)ethane; dihydroxydiphenylsulfones such as 4,4′-dihydroxydiphenylsulfon; dihydroxydiphenylethers such as 4,4′-dihydroxydiphenylether; and those wherein a portion of hydrogen atoms combined with these benzene rings are substituted with a lower alkyl group such as methyl, ethyl or propyl group, a lower alkoxy group such as methoxy, ethoxy or propyloxy group, or a halogen atom such as chlorine, bromine or fluorine atom. In view of cost and easy availability, hydroquinone, 4,4′-biphenol, 2,2-bis(4-hydroxyphenylpropane), 4,4′-dihydroxydiphenylether and 4,4′-dihydroxydiphenylsulfone are preferable, bisphenol selected from the group represented by the following formula (4) is more preferred, and 4,4′-dihydroxydipheylsulfone is particularly preferable. Two or more kinds of these dihydric phenol compounds may be used in combination.

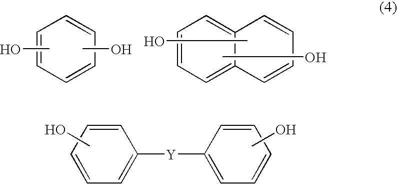

wherein Y and the positions of the two hydroxyl groups attached to the benzene or naphthalene rings are the same as described above and correspond to those of the PES-based resins (A) to be obtained.

The PES-based resin (A) used in the present invention is preferably obtained by polycondensing the dihydric phenol compound with an approximately equimolar amount of the dihalodiphenylsulfone compound, or may be obtained by polycondensing using an approximately equimolal amount (to the dihalodiphenylsulfone compound), or a slightly excessive or slightly smaller amount, of the dihydric phenol compound so that the molecular weight of the PES-based resin (A) can be controlled. A small amount of a monohalodiphenyl compound or a monohydric phenol compound may also be added in the polymerization system so as to control the molecular weight similarly.

A PES-based resin having a repeating unit represented by the following formula (2) (hereinafter referred to as a “formula (2) unit”):

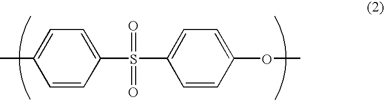

in the amount of 80% by mole or more of the total of entire repeating units is preferably used since such a PES-based resin has an excellent in heat resistance. From the viewpoint of the heat resistance, the amount of the formula (2) unit is more preferably 90% by mole or more, and a PES-based resin composed substantially composed of the formula (2) unit is particularly preferable.

The polycondensation reaction temperature in preparing the PES-based resin (A) is preferably within a range of from 140° C. to 340° C. When the reaction temperature is too high, the resultant PES-based resin may cause drastic coloration. In contrast, when the reaction temperature is too low, the polymerization rate decreases and it may become difficult to obtain a PES-based resin having a proper molecular weight within a practical reaction time.

Examples of the end (terminal) structure of the PES-based resin (A) include chlorine atom (—Cl), hydroxyl group (—OH), metal alkoxide group (—OM, wherein M is an atom of metal such as alkali metal) and alkoxy group (—OR″, wherein R″ is an alkyl group having about 1 to 3 carbon atoms). The kind and proportion (to the total of entire repeating units) of the end structure can be appropriately determined depending on the conditions for the production of the PES-based resin (A).

Thus, the PES-based resin (A) used in the present invention can be obtained by the methods described above, while the PES-based resin (A) may be a commercially available PES-based resin. Examples of the commercially available PES-based resin include SUMIKAEXEL PES3600P, 4100P, 4800P, 5200P, 5003P and 7600P (trade name) manufactured by Sumitomo Chemical Co., Ltd.; and UDELP-1700 (trade name) manufactured by AMOCO Co. Among these commercially available PES-based resins, PES-based resins commercially available under the trade name of SUMIKAEXEL are substantially composed of the formula (2) unit and are particularly preferable since they have excellent heat resistance.

A molecular weight of the PES-based resin (A) can be estimated by measuring a reduced viscosity (RV) of the solution of the resin. The PES-based resin (A) preferably has a molecular weight such that, when dissolved in dimethylformamide (DMF) to have a concentration of one (w/v) %, a reduced viscosity (RV) of the resultant solution is in the range of from 0.3 to 0.8.

The PES-based resin (A) preferably has a weight reduction starting temperature of 500° C. or higher. High heat resistance may be required to parts composed of the resin composition described hereinafter. In this respect, the PES-based resin having a weight reduction starting temperature of 520° C. or higher is more preferable. The weight reduction starting temperature can be determined by the method equivalent to the measuring method, JIS K 7120 (1997), described as for the weight reduction starting temperature of the low molecular weight compound (B).

A resin composition of the present invention comprises PES-based resin (A) and the low molecular weight compound (B) preferably in the content ratio (A):(B) of from 100:5 to 100:1 in terms of a weight ratio.

Please note that, for example, the “content ratio (A):(B) of 100:5 in terms of a weight ratio” means that 5 parts by weight of the compound (B) is added to 100 parts by weight of the PES-based resin (A).

As described above, the content ratio of the compound (A) and that of the compound (B) is preferable within a range from 100:5 to 100:1, and is more preferably from 100:3 to 100:1, in terms of a weight ratio. When the amount of the low molecular weight compound (B) is too small, melt processability of the resin composition may not be sufficiently enhanced and the out-gassing reduction effect may deteriorate. In contrast, when the amount of the low molecular weight compound (B) is too large, heat resistance of the resin composition may deteriorate easily. When two or more kinds of PES-based resins (A) are used in the composition, the total amount of the PES-based resins (A) may be adjusted so as to be within the above range of the weight ratio to the compound(s) (B). Similarly, when two or more kinds of low molecular compounds (B) are used, the total amount of the compound (B) may be adjusted so as to be within the above range of the weight ratio to the PES-based resin(s) (A).

The resin composition may contain, in addition to the compounds (A) and (B), fillers and additives as long as the intended effect of the present invention is not adversely affected. The resin composition may contain inorganic fillers for the purpose of improving characteristics such as mechanical properties and heat resistance. Examples of the inorganic filler include fiber- and needle-shaped reinforcers such as glass fiber, silica-alumina fiber, wollastonite and potassium titanate whisker; calcium carbonate, dolomite, talc, mica, clay and glass beads. If necessary, two or more kinds of inorganic fillers can also be used. Among them, the inorganic filler is preferably glass fiber. When the inorganic filler is used, the amount of the inorganic filler may be one part by weight or more, and preferably 10 parts or more, to 100 parts by weight of the PES-based resin (A) in view of the reinforcing effect of the resultant composition. In view of the moldability of the resultant composition, the amount of the inorganic filler may be 100 parts by weight or less, and preferably 70 parts or less, to 100 parts by weight of the PES-based resin (A). When the inorganic filler is used, the kind and amount thereof can be appropriately determied so as not to impair low out-gassing properties.

The resin composition of the present invention can be prepared by melt-kneading of the ingredients. For example, the PES-based resin (A) and the low molecular weight compound (B), and an optional inorganic filler and the like), are mixed with a Henschel mixer, a tumbler, or the like, followed by melt-kneading the resultant mixture with an extruder, to obtain a resin composition of the present invention. The melt of the componets extruded through an extruder is optionally cut by various conventionally known means so that the resin composition can be obtained in the form of pellets. It is preferable to obtain the resin composition in the form of pellets since the pellets are excellent in operability in the subsequent molding process.

Regarding the temperature conditions upon melt kneading, optimum conditions can be appropriately selected depending on the kind of the PES-based resin used. The temperature is preferably within a range of from 250° C. to 400° C., more preferably from 270° C. to 400° C., and most preferably within a range of from 300° C. to 400° C. As described above, since the resin composition of the present invention is preferably molded into pellets, it is preferred to employ, as the temperature conditions upon melt kneading, conditions that enable continuous production when a melt (strand) extruded through a dies after melt kneading is cooled and then is cut.

The resin composition thus obtained of the present invention can be molded into various parts and members by a conventional method. Examples of the molding method include injection molding method, compression molding method, extrusion molding method and hollow molding method. An injection molding method is preferable so as to obtain a molded article having a complicated shape.

The molded article can be preferably used for, in addition to electric and electronic parts such as relay part, connector, IC socket and IC tray; parts of household electric appliances, such as VTR, television set, iron, air-conditioner, stereo, cleaner, refrigerator, rice cooker and lighting equipment; parts of lighting equipment, such as lamp reflector, lamp holder and glass portion; parts of acoustic products system, such as compact disk, laser disk and speaker; parts of communication equipments, such as telephone parts, facsimile parts and modem; copy machine associated parts such as heater holder; automobile parts such as interior parts; parts of crafts; parts of space crafts; members of marine facilities; parts of optical equipments; valves; pipes; nozzles; filters; membranes; parts of medical equipments and medical materials; parts of sensors; sanitary fittings; sporting goods; leisure goods; films; and sheets. With respect to sockets for IC which can meet the multiple pin condition, such as pin grid array (PGA), ball grid array (BGA) or burn-in-socket, particularly burn-in-socket, since a conventional polyethersulfone-based resin composition has insufficient fluidity (melt processability), a portion of cavities of a mold are not completely filled with a melt resin composition, and thus satisfactory products are not obtained. According to the resin composition of the present invention, electric and electronic parts having a complicated shape can be molded with good moldability.

The molded article obtained by using the resin composition of the present invention is excellent in low out-gassing properties. Namely, the molded article may remarkably suppress the generation of gasses out of the article while being utilized. For example, the amount of the generated gas out of the article is 0.1 ppm by weight of less, when measured by the gas measuring method described below. The molded article can exert a remarkable effect of having excellent low out-gassing properties, compared to the molded articles obtained only from a PES-based resin as a resin component, and is particularly suited for use in electric and electronic parts.

The invention being thus described, it will be apparent that the same may be varied in many ways. Such variations are to be regarded as within the spirit and scope of the invention, and all such modifications as would be apparent to one skilled in the art are intended to be within the scope of the following claims.

### EXAMPLES

The present invention is described in more detail by following Examples, which should not be construed as a limitation upon the scope of the present invention.

### Examples 1 to 3, Comparative Example 1

Using a Henschel mixer, the following components were mixed according to the formulation (parts by weight) shown in Table 1 and then granulated at a cylinder temperature of 340° C. with a twin-screw extruder (Model PCM-30, manufactured by Ikegai Iron Works) to obtain a polyethersulfone-based resin composition.

The following was used as the polyethersulfone-based resin (A).

SUMIKAEXEL PES4800P (trade name) manufactured by Sumitomo Chemical Co., Ltd.

A reduced viscosity (RV) when measured in a 1 (w/v) % DMF solution is 0.48, and a weight reduction starting temperature is 500° C. or higher.

The following was used as the low molecular weight compound (B).

HFBA: hexafluorobisphenol (A) (manufactured by Central Glass Co., Ltd. under the trade name of BISAF)

Weight reduction starting temperature: 206° C.

Melting point: 164° C.

Molecular weight: 336

PNA: N-phenyl-2-naphthylamine (manufactured by Tokyo Chemical Industry Co., Ltd.)

Weight reduction starting temperature: 225° C.

Melting point: 111° C.

Molecular weight: 219

The weight reduction starting temperature of the polyethersulfone-based resin (A) and that of the low molecular weight compound (B) were measured under an air atmosphere at a heating rate of 10° C./min according to the method determined in JIS K 7120. The melting point of the low molecular weight compound (B) was measured under a nitrogen atmosphere at a heating rate of 20° C./min with Differential Scanning Calorimeter DSC50.

With respect to the polyethersulfone-based resin composition thus obtained, the following various characteristics were evaluated. The results are shown in Table 1.

### (1) Heat Resistance

Using an injection molder (Model PS40E5ASE, manufactured by Nissei Plastic Industrial Co., Ltd.), the resultant polyethersulfone-based resin composition was injection-molded at a cylinder temperature of 360° C. and a mold temperature of 150° C. to obtain a molded article having a thickness of 0.8 mm. Heat resistance of the resultant molded article was evaluated by heating under the conditions of a frequency of 10 Hz and 5° C./min in the tensile mode measurement using Viscoelastometer DMA2980 manufactured by TA Instruments, and measuring a glass transition temperature.

### (2) Fluidity (Melt Processability)

Using a high-speed injection molder (Model UH-1000, manufactured by Nissei Plastic Industrial Co., Ltd.), a spiral-shaped molded article measuring 8 mm in width and 1 mm in thickness was molded under the conditions of a cylinder temperature of 360° C., a mold temperature of 150° C. and an injection speed of 50 mm/sec. Then, fluidity was evaluated by the length from a gate inlet of the molded article to a flow tip.

### (3) Generated Gas

Using an injection molder (Model PS40E5ASE, manufactured by Nissei Plastic Industrial Co., Ltd.), the polyether-based resin compositions of Examples 1, 2 and 4 as well as Comparative Example 1 were injection-molded at a cylinder temperature of 360° C. and a mold temperature of 150° C. to obtain 1.2 mm thick molded articles. Each of the resultant molded articles was cut into pieces measuring 5 mm². After weighing 4.0 g, each sample was sealed in a 20 ml glass bottle equipped with septum and subjected to a heat treatment at 120° C. for 20 hours, and then a gas generated in the glass bottle was analyzed by gas chromatography.

The mass of a gas component detected at a temperature inside the column of 200° C. or higher was converted into the mass of phenol. The mass of phenol generated from unit mass of a sample to be measured was determined and then divided by the weight of the molded article to be measured to obtain the amount of the generated gas (ppm by weight). Details of measuring conditions are shown below.
GCMS: Agilient5973N (with FID)
Column: HR-1701 (0.25 mm in inner diameter×50 m, manufactured by Shimadzu Corporation)
Injection mode: Split (ratio 1:50)
Injection inlet temperature: 200° C.
Carrier gas: He (flow rate: 1.0 ml/min, constant flow mode)
Oven temperature setting: With maintaining at 40° C. for 5 minutes, followed by heating (heating rate: 10° C./min) and further maintaining at 260° C. for 5 minutes.

TABLE 1

| | | | | | Heat | Generated |
|---|---|---|---|---|---|---|
| | PES4800P | HFBA | PNA | | resist- | gas |
| | % by | % by | % by | Fluidity | ance | ppm by |
| | weight | weight | weight | cm | ° C. | weight |
| Example 1 | 100 | 1.01 | — | 7.2 | 253 | <0.1 |
| Example 2 | 100 | — | 1.01 | 6.6 | 250 | — |
| Example 3 | 100 | — | 3.09 | 7.7 | 238 | <0.1 |
| Compar- | 100 | — | — | 5.6 | 259 | 0.1 |
| ative | | | | | | |
| Example 1 | | | | | | |

It was found that, when mixed with HFBA or PNA, the resin compositions of the present invention (Examples 1 to 3) are excellent in fluidity (melt processability) when compared with PES4800P (Comparative Example 1) where such a low molecular weight compound (B) is not used. It was also found that a gas generated (out-gassing) can be reduced when compared with PES4800P where a low molecular weight compound (B) is not used.

What is claimed is:

1. A resin composition comprising the following components (A) and (B):
(A) a polyethersulfone-based resin, and
(B) a compound having a weight reduction starting temperature determined in JIS K7120 of 150° C. or higher, a melting point of 100° C. or higher and a molecular weight of 500 or less,
wherein a content ratio (A):(B) is within a range of from 100:5 to 100:1 in terms of a weight ratio.

2. The resin composition according to claim 1, wherein the compound (B) is a compound having one or more of polar functional groups selected from the group consisting of an acidic group and a basic group.

3. The resin composition according to claim 2, wherein the polar functional group is a functional group selected from the group consisting of an amino group and a phenolic hydroxyl group.

4. The resin composition according to claim 1, wherein the compound (B) is an aromatic compound.

5. The resin composition according to claim 1, wherein the compound (B) is a compound selected from the group consisting of hexafluorophenol A and N-phenyl-2-naphthylamine.

6. The resin composition according to claim 1, wherein the polyethersulfone-based resin (A) is a resin having a repeating unit represented by the formula (1) below: 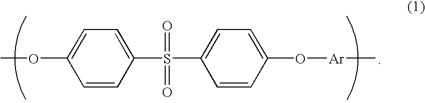
wherein Ar represents a divalent group which is selected from the following divalent groups: 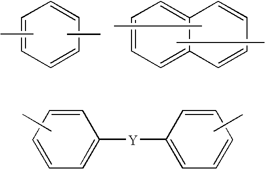
wherein Y represents SO₂, C(CH₃)₂ or O.

7. The resin composition according to claim 1, wherein the polyethersulfone-based resin (A) is a polyethersulfone-based resin having a repeating unit represented by the formula (2) below:

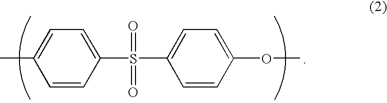

8. The resin composition according to claim 1, wherein the composition is a composition obtainable by melt-kneading the polyethersulfone-based resin (A) and the compound (B) in a ratio within a range of from 100:5 to 100:1, in terms of a weight ratio.

9. A molded article obtainable by melt-molding the resin composition according to claim 1.

10. A molded article obtainable by melt-molding the resin composition according to claim 8.

11. A method for producing a composition of polyethersulfone-based resin, the method comprising the steps of mixing
(A) a polyethersulfone-based resin, and
(B) a compound having a weight reduction starting temperature determined in JIS K7120 of 150° C. or higher, a melting point of 100° C. or higher and a molecular weight of 500 or less,
and then melt-kneading the resultant mixture with an extruder, to obtain the resin composition.
